(19) United States
(12) Patent Application Publication
(10) Pub. No.: US 2024/0424808 A1
(43) Pub. Date: Dec. 26, 2024

(54) THERMAL PRINTER

(71) Applicant: TOSHIBA TEC KABUSHIKI KAISHA, Tokyo (JP)

(72) Inventor: Hiroyuki TAKI, Mishima Shizuoka (JP)

(73) Assignee: TOSHIBA TEC KABUSHIKI KAISHA, Tokyo (JP)

(21) Appl. No.: 18/340,327

(22) Filed: Jun. 23, 2023

(51) Int. Cl. B41J 2/365; B41J 2/335; G01K 7/22

(52) U.S. Cl. CPC B41J 2/365; B41J 2/33505; G01K 7/22; B41J 2202/31

(57) ABSTRACT

A thermal printer with a thermal head including a heating element forms an image on a medium. The printer includes a temperature sensor that measures a temperature of the medium, a heater that heats an interior of the thermal printer, and a processor. The processor determines whether a temperature measured by the temperature sensor is equal to or greater than a preset temperature threshold, operate the heater if the measured temperature is less than the temperature threshold, and determine an application energy amount for the thermal head based on the measured temperature if the measured temperature is equal to or greater than the temperature threshold.

### FIELD

Embodiments described herein relate generally to a thermal printer.

### BACKGROUND

Thermal printers include thermal heads. The thermal heads include heating elements that print on various media. Thermal printers perform printing in accordance with a direct thermal sensitive record printing mode or printing in accordance with a thermal transfer mode. In the direct thermal sensitive record printing mode, printing is performed by causing a thermal head to heat a medium of which color is changed by heat. In the thermal transfer mode, printing is performed by causing a thermal head to heat ink. If such a thermal printer is used in a low temperature environment, printing quality deteriorates in some cases.

### DESCRIPTION OF THE DRAWINGS

FIG. 1 is a schematic perspective view illustrating a thermal printer used as an in-line printer according to a first embodiment;

FIG. 2 is a schematic side view illustrating an internal configuration of the thermal printer;

FIG. 3 is a block diagram illustrating a configuration of a control system of the thermal printer;

FIG. 4 is a schematic plan view illustrating a position at which a heater is disposed in the thermal printer;

FIG. 5 is a flowchart illustrating an operation of adjusting a thermal printer;

FIG. 6 is a diagram illustrating an adjustment table; and

FIG. 7 is a schematic view illustrating an internal configuration of a thermal printer according to a second embodiment.

### DETAILED DESCRIPTION

An exemplary embodiment provides a technology capable of preventing deterioration in printing quality in a low temperature environment.

In general, according to one embodiment, a thermal printer includes a thermal head which includes a heating element that forms an image on a medium. The thermal printer includes a temperature sensor that measures a temperature of the medium, a heater that heats an interior of the thermal printer, and a processor. The processor is configured to determine whether a temperature measured by the temperature sensor is equal to or greater than a preset temperature threshold, operate the heater if the measured temperature is less than the temperature threshold, and determine an application energy amount for the thermal head based on the measured temperature if the measured temperature is equal to or greater than the temperature threshold.

Hereinafter, embodiments will be described with reference to the drawings. In each drawing, the same reference numerals are given to the same configurations.

### First Embodiment

### Configuration of Thermal Printer

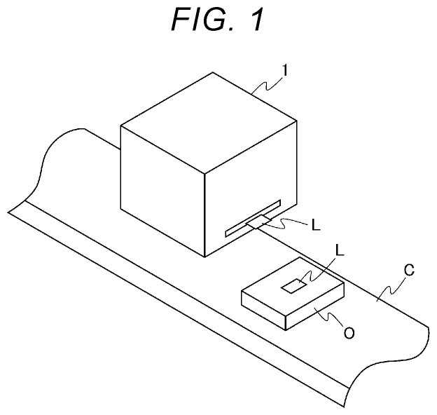

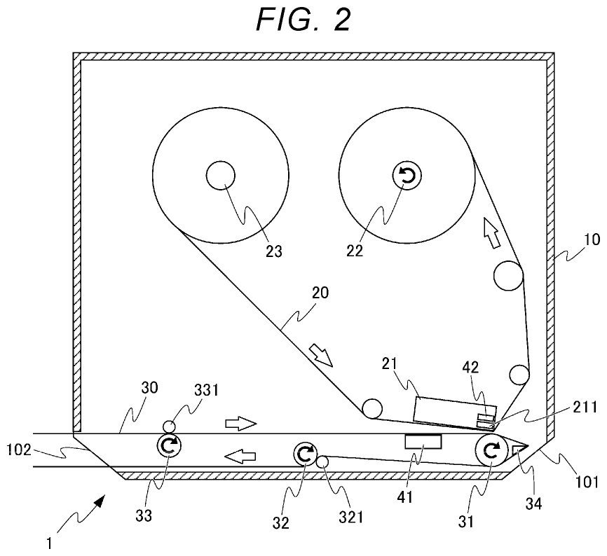

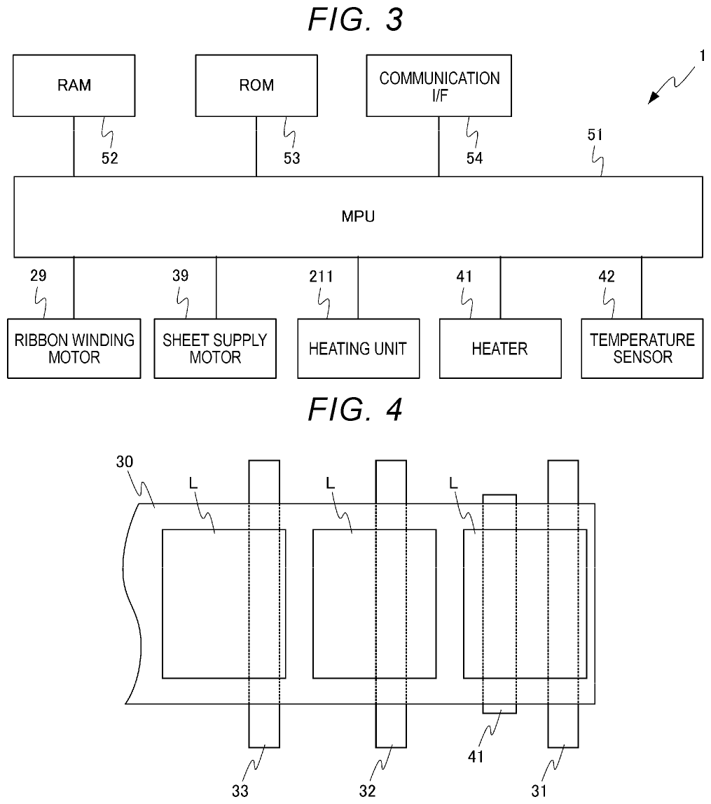

A configuration of a thermal printer according to a first embodiment will be described. FIG. 1 is a schematic perspective view illustrating the thermal printer used as an in-line printer according to the embodiment. FIG. 2 is a schematic side view illustrating an internal configuration of the thermal printer according to the embodiment. FIG. 3 is a block diagram illustrating a configuration of a control system of the thermal printer according to the embodiment. FIG. 4 is a schematic plan view illustrating a position at which a heater is disposed in the thermal printer according to the embodiment. The thermal printer of which only a casing is cutaway is illustrated in FIG. 2.

As illustrated in FIG. 1, a thermal printer 1 according to the embodiment is used as an in-line printer installed in a work place or the like. Specifically, in the embodiment, the thermal printer 1 is fixedly installed with respect to a conveyance device C conveying an object O and prints a label L to be attached to the object O. The label L is supplied to the thermal printer 1 by another device (not illustrated). Similarly, the label L printed by the thermal printer 1 is attached to the object O by another device (not illustrated).

As illustrated in FIG. 2, the thermal printer 1 is a thermal transfer printer that transfers ink to the label L by heat. The thermal printer 1 includes a casing 10, a thermal head 21, a ribbon winding shaft 22, a ribbon supporting shaft 23, a platen roller 31, a peeling roller 32, a counter roller 321, a capstan roller 33, a counter roller 331, and a peeling bar 34.

As illustrated in FIG. 3, the thermal printer 1 further includes a ribbon winding motor 29, a sheet supply motor 39, a heater 41, a temperature sensor 42, a micro processor unit (MPU) 51, a random access memory (RAM) 52, a read-only memory (ROM) 53, and a communication interface (I/F) 54.

The casing 10 is formed in a substantially rectangular shape that has an inner space for accommodating the above-described constituent elements. In the casing 10, a label discharging port 101 and a sheet feeding and discharging port 102 are formed. The label discharging port 101 is an opening formed by cutting off a side of the front (the right in FIG. 2) located on the bottom surface side of the casing 10. The sheet feeding and discharging port 102 is an opening formed by cutting off a side on the rear (the left in FIG. 2) located on the bottom surface side of the casing 10. A sheet 30 to which a plurality of labels L are continuously attached is supplied from the sheet feeding and discharging port 102. Each of the plurality of labels L attached to the sheet 30 is discharged from the label discharging port 101. The sheet 30 from which the label L is peeled is discharged from the sheet feeding and discharging port 102.

The ribbon supporting shaft 23 pivotally supports an ink ribbon 20 in which a belt-like member coated with ink is wound in a roll shape so that the ink ribbon 20 can be rotated. The ribbon winding shaft 22 is rotated by the ribbon winding motor 29 to wind the ink ribbon 20 unwound from the roll. The ribbon supporting shaft 23 and the ribbon winding shaft 22 are provided at the same position in the vertical direction. The ribbon supporting shaft 23 is located on the rear side of the ribbon winding shaft 22.

The thermal head 21 is provided below the ribbon supporting shaft 23 and the ribbon winding shaft 22 and includes a heating unit (e.g., a heating element, a heat source, a heater, etc.) 211 and a temperature sensor 42. The ink ribbon 20 unwound from the roll passes through the thermal head 21 and is wound on the ribbon winding shaft 22. The heating unit 211 is provided near the ink ribbon 20 passing through the thermal head 21, specifically, at a front end of the lower side of the thermal head 21. The heating unit 211 includes a plurality of heating elements adjacent to each other in the width direction of the label L. The plurality of heating elements generate heat in accordance with input pulsed waves. Accordingly, the thermal head 21 transfers the ink applied on the ink ribbon to the label L to form an image. The temperature sensor 42 measures a temperature of the sheet 30 and is configured as a thermistor provided in the thermal head 21 in the embodiment.

The capstan roller 33 is provided on the rear side of the platen roller 31 and the peeling roller 32. The capstan roller 33 conveys the sheet 30 supplied from the sheet feeding and discharging port 102 to the front side on which the thermal head 21 is located. The sheet 30 conveyed by the capstan roller 33 is positioned above the capstan roller 33 so that a rear surface to which the plurality of labels L are not attached comes into contact with the capstan roller 33. The counter roller 331 is provided to face the capstan roller 33 with the sheet 30 interposed therebetween. The capstan roller 33 conveys the sheet 30 while pinching the sheet 30 in cooperation with the counter roller 331.

The platen roller 31 is located in front of each of the capstan roller 33 and the peeling roller 32 and is configured to press the label L against the thermal head 21. The platen roller 31 conveys the sheet 30 to the front side on which the label discharging port 101 is provided on the upper side and conveys the sheet 30 to the rear side on which the sheet feeding and discharging port 102 is provided on the lower side.

The peeling bar 34 is located in front of the platen roller 31 and is provided near the label discharging port 101. The peeling bar 34 is formed in a long shape equal to or greater than a width of the label L and a corner is formed at an end on the front side across the entire region in the longitudinal direction. The sheet 30 conveyed to the front side is turned back to be conveyed to the rear side using the corner of the peeling bar 34 as a base point. The peeling bar 34 discharges the printed label L from the label discharging port 101 by protruding the rear surface of the sheet 30 forward.

The peeling roller 32 is provided to be located between the platen roller 31 and the capstan roller 33 in a front and rear direction. The peeling roller 32 conveys the sheet 30 from which the label L is peeled to the rear side on which the sheet feeding and discharging port 102 is located. The sheet 30 conveyed to the peeling roller 32 is positioned below the peeling roller 32 so that the rear surface comes into contact with the peeling roller 32. The counter roller 321 is provided to face the peeling roller 32 with the sheet 30 interposed therebetween. The peeling roller 32 conveys the sheet 30 while pinching the sheet 30 in cooperation with the counter roller 321. The sheet supply motor 39 rotates the platen roller 31, the peeling roller 32, and the capstan roller 33.

As illustrated in FIG. 2, the heater 41 is provided to heat the sheet 30 inside the casing 10. Specifically, the heater 41 is provided to heat the sheet 30 upstream from the heating unit 211 of the thermal head 21 in a conveyance direction. Therefore, as illustrated in FIG. 4, the heater 41 is positioned between the platen roller 31 and the peeling roller 32 adjacent to the platen roller 31 in the front and rear direction, that is, in the conveyance direction of the sheet 30. In FIG. 4, the counter rollers 321 and 331 are not illustrated.

Further, the heater 41 is interposed between the supplied sheet 30 positioned on the upper side, and the sheet 30 positioned on the lower side and discharged, wherein the heater 41 is provided closer to the side of the supplied sheet 30. Accordingly, the heater 41 can be disposed inside a space partially defined by the sheet 30 located on the upper side and the lower side to provide heat from the heater 41 more efficiently. The heater 41 is preferably formed so that a length of the heater 41 in the horizontal direction is equal to or greater than the width of the label L. By increasing the length of the heater 41 in the front and rear direction, it is possible to increase a time in which the conveyed label L is heated.

The communication I/F 54 performs communication with a host device of the thermal printer 1. The MPU 51 controls the ribbon winding motor 29, the sheet supply motor 39, and the heating unit 211 in cooperation with the RAM 52 to form an image received from the host device on the label L. Further, the MPU 51 controls (e.g., adjusts, etc.) the heater 41 based on the temperature measured by the temperature sensor 42 before the image is formed on the label L. The ROM 53 stores a program and data used for a process of the MPU 51.

### Operation of Adjusting

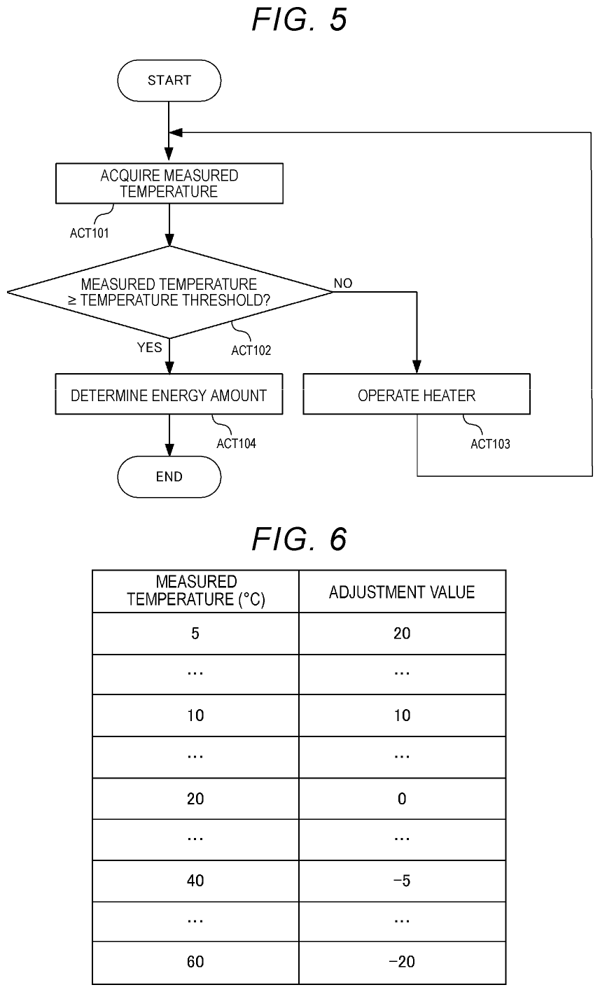

An operation of adjusting the heater 41 according to the first embodiment will be described. FIG. 5 is a flowchart illustrating the operation of the adjusting according to the embodiment. FIG. 6 is a diagram illustrating an adjustment table according to the embodiment. The adjusting illustrated in FIG. 5 is assumed to be performed until printing starts after start of an operation of the thermal printer.

As illustrated in FIG. 5, the MPU 51 first acquires the temperature measured by the temperature sensor 42 as a temperature of the sheet 30 (ACT101). Subsequently, the MPU 51 determines whether the acquired measured temperature is equal to or greater than a preset temperature threshold (ACT102). Here, the temperature threshold is a temperature at which the thermal printer 1 can perform printing so that a printing failure does not occur on the label L and is set to 5° C. in the embodiment.

If the measured temperature is less than the temperature threshold (NO in ACT102), the MPU 51 operates the heater 41 (ACT103), acquires the measured temperature (ACT101), and determines whether the measured temperature is equal to or greater than the temperature threshold (ACT102).

Conversely, if the measured temperature is equal to or greater than the temperature threshold (YES in ACT102), the MPU 51 determines an application energy amount to the heating unit 211, that is, a duty ratio of a pulsed wave input to the heating unit 211, if the printing is performed on the label L (ACT104).

Here, a method of determining the energy amount will be described. As illustrated in FIG. 6, the MPU 51 determines the energy amount based on the adjustment table in which measured temperatures are associated with adjustment values. Specifically, the MPU 51 adds an adjustment value associated with an acquired measured temperature to a reference energy amount and adjusts the application energy amount.

In the adjustment table, an adjustment value corresponding to a reference temperature set to 20° C. is zero. In the adjustment table, as the measured temperature is lower than the reference temperature, the measured temperature is associated with a larger positive adjustment value. As the measured temperature is higher than the reference temperature, the measured temperature is associated with a smaller negative adjustment value. The application energy amount may be determined by calculating a larger application energy amount as the reference temperature is lower and by calculating a smaller application energy amount as the reference temperature is higher.

In this way, if the measured temperature of the sheet 30 does not reach the temperature threshold, a printing failure in a low-temperature environment can be prevented by causing the heater 41 to heat the sheet 30. By adjusting the application energy amount in accordance with a relative measured temperature of the sheet 30 with respect to the reference temperature, it is possible to further prevent deterioration in printing quality caused by a temperature environment.

### Second Embodiment

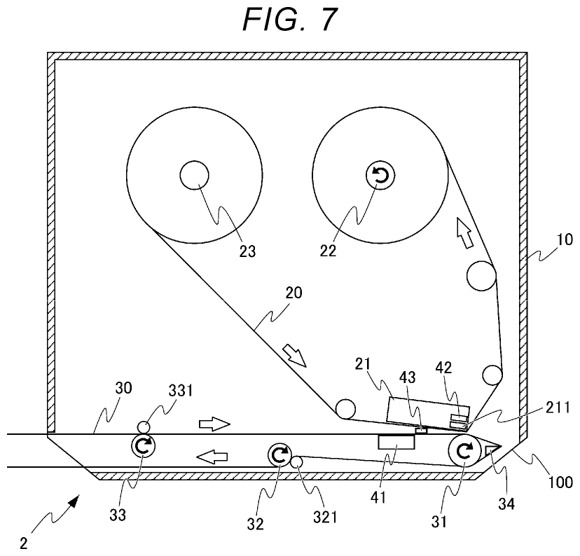

A thermal printer according to a second embodiment will be described. FIG. 7 is a schematic view illustrating an internal configuration of the thermal printer according to the embodiment.

As illustrated in FIG. 7, a thermal printer 2 according to the embodiment is different from the thermal printer 1 according to the first embodiment in that a temperature sensor 43 is further included. The temperature sensor 43 is provided to measure a temperature of the sheet 30 heated by the heater 41. More specifically, the temperature sensor 43 is provided at (e.g., proximate to) the front surface side of the sheet 30 at a position in the conveyance direction upstream from the platen roller 31 and downstream from the heater 41. In the embodiment, the temperature sensor 43 is provided to be located between the ink ribbon 20 and the sheet 30.

In the embodiment, the MPU 51 acquires a temperature measured by the temperature sensor 43 rather than the temperature sensor 42 as a temperature of the sheet 30 used for the adjusting. Accordingly, the heater 41 can be operated and the application energy amount can be determined based on a more accurate measured temperature of the sheet 30 than in a case where the temperature sensor 42 provided in the thermal head 21 is used.

In the above-described embodiment, the thermal printers 1 and 2 perform printing in accordance with the thermal transfer mode, but may perform printing in accordance with the direct thermal sensitive record printing mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A thermal printer comprising:
a thermal head comprising a heating element, the thermal head configured to form an image on a medium;
a temperature sensor configured to measure a temperature of the medium;
a heater configured to heat an interior of the thermal printer; and
a processor configured to:
determine whether a temperature measured by the temperature sensor is equal to or greater than a preset temperature threshold;
in response to the temperature being less than the preset temperature threshold, operate the heater; and
in response to the temperature being equal to or greater than the preset temperature threshold, determine an application energy amount for the thermal head based on the measured temperature.

2. The printer according to claim 1, wherein in response to the temperature being less than the preset temperature threshold, the processor is configured to determine a larger application energy amount.

3. The printer according to claim 2, wherein in response to the temperature being equal to or greater than the preset temperature threshold, the processor is configured to determine a smaller application energy amount.

4. The printer according to claim 1, wherein the heater is configured to provide heat to the medium.

5. The printer according to claim 1, wherein
the medium is a sheet shape and is conveyed such that the medium is provided in a first direction and is discharged in a second direction after the medium passes through the thermal head, and
the heater is positioned between the medium provided in the first direction and the medium discharged in the second direction.

6. The printer according to claim 5, wherein the heater is positioned adjacent to the medium provided in the first direction.

7. The printer according to claim 1, wherein
the medium is conveyed by a plurality of rollers, and
the heater is positioned between a platen roller pressing the medium against the thermal head and a roller adjacent to the platen roller in a conveyance direction of the medium.

8. The printer according to claim 1, wherein the temperature sensor is positioned in the thermal head.

9. The printer according to claim 8, wherein the temperature sensor is a thermistor.

10. The printer according to claim 8, further comprising a second temperature sensor positioned proximate to the medium.

11. The printer according to claim 6, wherein the temperature sensor is configured to measure a temperature of a surface of the medium on a side opposite to a side on which the heater is positioned.

12. The printer according to claim 10, wherein the temperature sensor is positioned downstream from the heater and upstream from the thermal head in a conveyance direction of the medium.

13. The printer according to claim 1, wherein the heating element is positioned in a front end of a lower side of the thermal head.

14. A method for controlling a thermal printer comprising:
determining whether a temperature of a medium is equal to or greater than a preset temperature threshold;
in response to the temperature being less than the preset temperature threshold, operating a heater; and
in response to the temperature being equal to or greater than the preset temperature threshold, determining an application energy amount for the thermal head based on the measured temperature.

15. The method of claim 14, further comprising acquiring, from a temperature sensor, the temperature.

16. The method of claim 14, wherein operating the heater comprises providing heat to the medium.

17. The method of claim 14, further comprising associating the temperature with an adjustment value.

18. The method of claim 17, wherein when the temperature is lower than the preset temperature threshold, the temperature is associated with a positive adjustment value.

19. The method of claim 17, wherein when the temperature is higher than the preset temperature threshold, the temperature is associated with a negative adjustment value.

20. The method of claim 17, further comprising:
adding the adjustment value associated with the temperature to a reference energy amount; and
adjusting the application energy amount based on the adjustment value.
